(19) United States
(12) Patent Application Publication
(10) Pub. No.: US 2017/0172837 A1
(43) Pub. Date: Jun. 22, 2017

(54) A BODYCARE DEVICE

(71) Applicant: KONINKLIJKE PHILIPS N.V., EINDHOVEN (NL)

(72) Inventors: KE YANG, EINDHOVEN (NL); SEVERIN LUC RAMSES HARVEY, EINDHOVEN (NL)

(21) Appl. No.: 15/320,786

(22) PCT Filed: Jun. 25, 2015
(86) PCT No.: PCT/EP2015/064333

§ 371 Date: Dec. 21, 2016

(30) Foreign Application Priority Data
Jun. 30, 2014 (EP) 14174901.0

(51) Int. Cl. A61H 7/00; A61H 23/02; A45D 40/00

(52) U.S. Cl. CPC A61H 7/005; A45D 40/00; A61H 23/0254; A61H 2201/1238; A61H 2205/024; A61H 2201/1671; A61H 2201/0153

(57) ABSTRACT

The present application relates to a bodycare device (10) for performing a skincare procedure on a periorbital area of a subject. The bodycare device (10) has a treatment head (30) with a treatment surface (37) having a curved profile and a surface roughness Ra between 1 μm and 4 μM. A driver is configured to cause a rotational motion and an axial vibratory motion of the treatment head (30). The present application also relates to a treatment head (30) for a bodycare device (10) for performing a skincare procedure on a subject.

### FIELD OF THE INVENTION

The present invention relates to a bodycare device for performing a skincare procedure on a subject. The present invention also relates to a treatment head for a bodycare device for performing a skincare procedure on a subject.

### BACKGROUND OF THE INVENTION

Bodycare devices such as skincare devices are known to apply a treatment to the periorbital area under the eye, that is the area of skin below a subject's eye. Such a device is known to provide a handle having a roller ball rotatably mounted therein for applying a moisturizing cream to the skin, particularly around a subject's eye together with an urging force. However, such arrangements require the provision of a fluid to be applied to the skin, and may become clogged.

WO2003/068130 describes a process for making a massage device comprising taking the body and motor of an electric toothbrush and a brush head therefor; and adapting the bristle head of said brush head to produce a massage head that is substantially smooth and devoid of bristles.

GB1293876 describes an appliance for administering cosmetics to the skin comprises a detachable skin treating head with bristles, a shank and a handle containing an electric motor, a battery power supply, and a pivoted drive lever connecting the head to the motor. In use the motor rotates gear-member, consequently cam and follower impart a reciprocating motion on to lever that is transmitted to the head as an elliptical vibration. The bristled head may be replaced by a massaging head comprising an elliptical frame and a shank identical to that on head. If so desired a container in the head may be filled with water and frozen in a domestic refrigerator. This container is covered by a smooth aluminium cap that applies the vibrations to the patient's body. If a rechargeable battery is used, the appliance may be detachably mounted in a charging stand. This contains a circuit that induces a charging current into circuit connected to the battery.

U.S. Pat. No. 6,139,553 describes an implement for and a method of, facial treatment are described in which a facial preparation containing an abrasive is applied to the face, and a facial treatment head is pressed against the facial preparation and is vibrated to work the facial preparation into the skin of the subject's face. Preferably, the facial treatment head includes a convexly-curved surface, but may also be one including a rotary disk which is rotated and vibrated while pressed into contact with the facial preparation on the subject's face. The facial preparation is preferably a mud mixture; preferably, this treatment is followed by another one utilizing a facial preparation containing a moisturizer which is also worked into the skin in a similar manner as the mud treatment.

WO2013/114127 describes a manual device for massaging one or both of the upper and lower lids of the eye, the device comprising: a body, composed of flexible resilient biocompatible material, wherein the body provides jaws or lips, wherein the lips are biased into a spaced relationship by the material of the body, and wherein each lip is adapted to engage either the upper or lower eyelid, such that movement of the lips causes movement of at least one eyelid with respect to the other. The devices can be used to manipulate the meibomian glands of the eye in an optimum orientation, for example for alleviating or treating dry eye.

WO2014/009177 describes a device for treating skin comprising a housing, a shaft located in the housing having a longitudinal axis and an end for receiving a skin treating part. The device further comprises a drive means configured to cause the shaft to rotate about its longitudinal axis, and to oscillate in a direction along the longitudinal axis, wherein the drive means comprise a rotational drive unit for rotating the shaft and an oscillation generator for oscillating the shaft. The oscillation generator is located about the shaft such that the shaft is rotatable relative to the oscillation generator. Furthermore, the oscillation generator comprises a solenoid and a flux assembly, and the flux assembly is moveable along the shaft relative to the solenoid.

### SUMMARY OF THE INVENTION

It is an object of the invention to provide a bodycare device and/or a treatment head for a bodycare device which alleviates or substantially overcomes the problems mentioned above.

The invention is defined by the independent claims; the dependent claims define advantageous embodiments.

According to one aspect of the present invention, there is provided a bodycare device for performing a skincare procedure on a periorbital area of a subject, comprising a treatment head with a treatment surface having a curved profile and especially having a surface roughness Ra between 1 μm and 4 μm, a driver configured to cause a rotational motion and an axial vibratory motion of the treatment head. Further, in another aspect the invention also provides the treatment head per se, i.e. especially a treatment head for a bodycare device for performing a skincare procedure on a periorbital area of a subject comprising a treatment surface having a curved profile and especially a surface roughness Ra between 1 μm and 4 μm, wherein the treatment head is configured for rotation and axial vibration by the driver.

With this arrangement it is possible to apply a soothing effect to the periorbital area of the subject. The combination of the curved profile of the treatment head together with the rotational and axial vibratory motion of the treatment head provides a synergistic effect to maximise lymph fluid drainage of the periorbital area of a subject. A vibratory action helps to generate peristaltic movements in the lymph vessels which together with a rotary motion creating a deformation to move the lymph fluid towards the lymph nodes helps to maximise drainage. Hence, in an embodiment the body care device is configured to cause a rotational motion and/or an axial vibratory motion of the treatment head during operation of the device, especially at least the rotational motion, and even more especially both the rotational motion and the axial vibratory motion. The surface roughness means that it is possible to ensure that the treatment head is able to act on and move along the skin of a subject without dragging on or pulling the skin. This helps to prevent any irritation or soreness due to friction between the skin and the treatment head.

The treatment head may be radially symmetric.

Therefore, the user is able to position the treatment head against the periorbital area of of the subject without having to specifically orientate the treatment head. Furthermore, this minimises user anxiety about damaging the periorbital area which helps to promote the soothing effect of the device.

At least a section of the curved profile of the treatment surface may be dome shaped.

With this arrangement it is possible to apply an urging force on the skin of the subject without potential damage to the skin.

The curved profile of the treatment surface may be a rounded conical profile.

This means that the pressure applied to the skin may be dissipated across part of the treatment surface. Furthermore, it is possible to treat a greater area which minimises the number of strokes a user is required to make.

The treatment head may comprise two or more treatment sections, and each treatment section forming treatment surfaces.

The driver may be configured to rotate the treatment head about the symmetrical axis of the treatment head.

With this arrangement, the driver is configured to rotate the treatment head about an axis transverse to the plane of the skin against which the treatment head is applied.

The treatment head may have a connector to connect the treatment head to a main body of the bodycare device, the or each treatment surface being fixedly disposed relative to the connector.

With this arrangement, it is possible to restrict movement of the treatment surface relative to the connector. Therefore, detritus and bacteria are restricted from accumulating between the connector and the treatment surface.

The treatment head may be configured for use on a periorbital area of a subject.

An outer layer may form the treatment surface. The outer layer may have a heat transfer coefficient capable of drawing and/or applying heat from the periorbital area of the subject to be treated. Passive means of drawing and/or applying heat from the area of the subject to be treated may be used.

With the above arrangements it has been found that the combination of applying a rotational motion and an axial vibratory motion together with applying a temperature change to the area of the skin to be treated has a synergistic effect of maximising lymph drainage. This helps to maximise the healthiness and appearance of the area of the skin to which treatment is applied. It will be understood that the treatment head may be heated or cooled prior to use, for example by placing in contact with warm or cool water, and that the heat capacity will enable the temperature to be substantially retained prior to use. The outer layer may have a thermal conductivity of greater than or equal to 2 W·m−1·K−1, even more especially greater than or equal to 10 W·m−1·K−1, yet even more especially greater than or equal to 20 W·m−1·K−1. Good examples of thermally conductive materials include amongst others titanium, steel and aluminium (and alloys thereof).

This means that it is possible to draw heat from the periorbital area of skin by applying only passive cooling or heating based on the thermal conductivity of the outer layer. Therefore, the complexity of the treatment head, and therefore the reliability is maximised.

The treatment surface may especially have a surface roughness Ra between 1 μm and 2 μm. Especially, the surface roughness Ra is at least 1.5 μm.

The driver may be configured to cause a rotational motion between 100 rpm and 200 rpm and, optionally, between 120 rpm and 170 rpm.

It has been found that causing a rotational motion between 100 rpm and 200 rpm and, optionally, between 120 rpm and 170 rpm maximises the reduction of puffiness in the periorbital area of skin.

The driver may be configured to cause an axial vibratory motion especially having an amplitude of greater than or equal to 20 μm and, optionally, greater than or equal to 30 μm, and less than 600 μm, and optionally, less than 300 μm. The driver may be configured to cause an axial vibratory motion especially having a frequency between 50 Hz and 150 Hz and, optionally, between 100 Hz and 140 Hz.

It has been found that the above ranges maximise the efficiency of the skincare procedure applied to the subject. This helps to minimise the length of time required to achieve the desired effect.

The treatment head may be detachable from a main body of the bodycare device.

With this arrangement, it is possible to aid cleaning of the bodycare device or applying a temperature change to the treatment head. Furthermore, the treatment head may be interchangeable with another head having different properties. This may allow differing treatments to be applied on a subject.

Hence, according to another aspect of the present invention (see also above), there is provided a treatment head for a bodycare device for performing a skincare procedure on a periorbital area of a subject comprising a treatment surface having a curved profile and especially a surface roughness Ra between 1 μm and 4 μm, and (optionally) a connector for connecting the treatment head to a driver, wherein the treatment head is configured for rotation and axial vibration by the driver. Such connector may be configured for removably mounting to the driver or configured for a fixed mounting to a driver (of the treatment head).

The body care device may have an elongated shape, i.e. having an aspect ratio of a length relative to a width, or an aspect ratio of a length relative to a diameter, of at least 2, such as at least 5. Especially, the body care device is configured to be a handheld device. Hence, for this reason the body care device may have an elongated shape, notwithstanding e.g. the presence of a grip part, etc. Therefore, the body care device may include a body axis (herein also indicated as “device axis”). The rotational axis may be configured substantially parallel and in line with this body axis (see also FIG. 1). This may facilitate the axial vibratory motion. Alternatively, there may be a (small) angle between the body axis and the rotational axis, such as in the range of larger than 0 and equal to or smaller than 45°, such as equal to and smaller than 30° (see also FIG. 2).

In an embodiment, the treatment head comprises a connector. For instance, the connector may extend from a lower end of a base of the connector. Further, in embodiments the connector may be integrally formed with the base. Especially, the connector may include an engagement arrangement for an engagement with the a drive shaft. The bodycare device may especially include a driver for actuating the treatment head. The treatment head may be received on a drive shaft. To this end, the connector (including the engagement arrangement) may be applied. Especially, the connector of the treatment head is configured (optionally in combination with a corresponding element on the drive shaft) to ensure that the treatment head rotates together with the drive shaft (when the treatment head is mounted thereon) during operation of the body care device.

In yet a further embodiment, the invention also provides a non-medical method, such as a cosmetic method, comprising performing a skincare procedure on a periorbital area of a subject, wherein the herein described bodycare device is used while contacting the periorbital area of the subject with the treatment head, while the treatment head is rotating and/or vibrating, such as with the herein described rotational motion and/or vibrational motion.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 is a schematic perspective view of a facial bodycare device, with a charging cradle and interchangeable treatment head;

FIG. 2 is a schematic illustration of the facial skincare device in use by a subject;

FIG. 3 is a schematic side view of the facial skincare device shown in FIG. 1;

FIG. 4 is a schematic side view of the interchangeable treatment head shown in FIG. 1;

FIG. 5 is a schematic perspective view of another embodiment of an interchangeable treatment head for the facial bodycare device shown in FIG. 1; and

FIG. 6 is a schematic perspective view of another embodiment of an interchangeable treatment head for the facial bodycare device shown in FIG. 1.

### DETAILED DESCRIPTION OF THE EMBODIMENTS

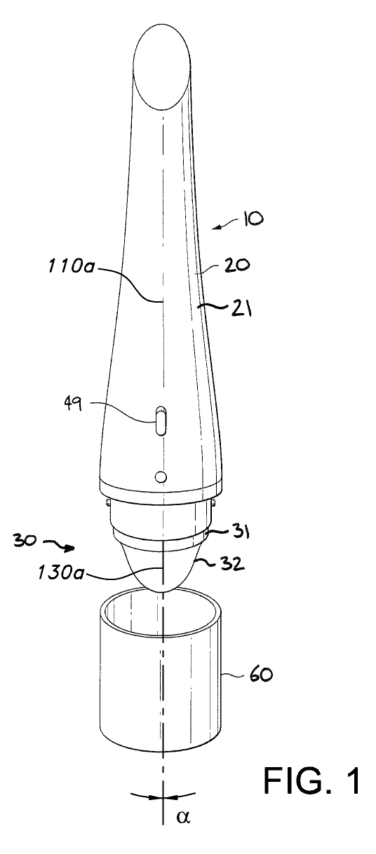

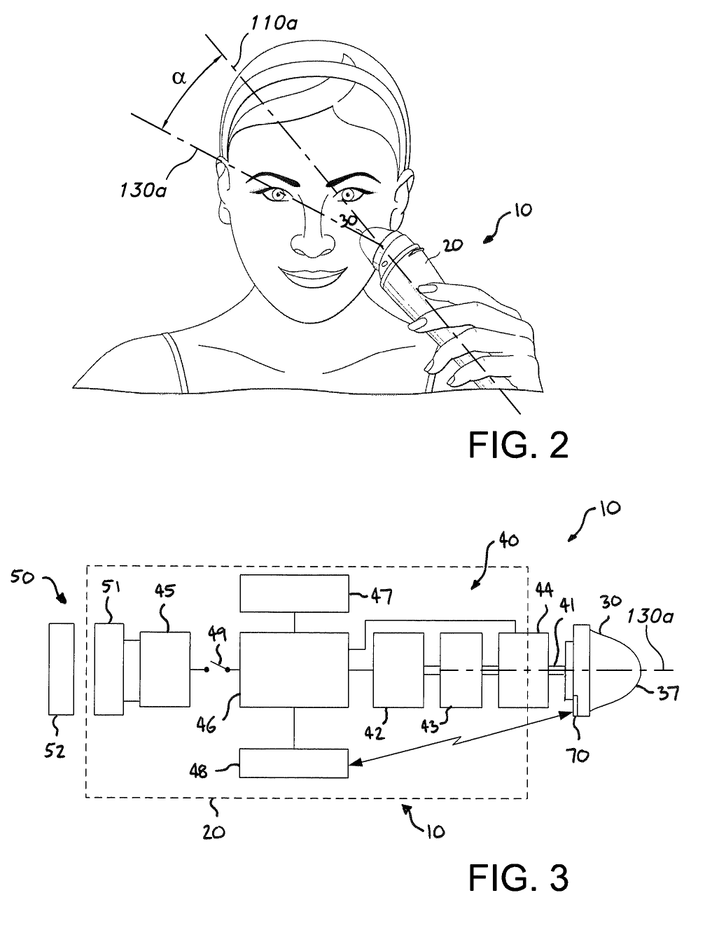

Referring to FIG. 1, a handheld bodycare device 10 is shown. The bodycare device 10 has a main body 20. The main body 20 has a housing 21. The housing 21 is waterproof. The bodycare device 10 has a rotary and vibratory treatment head 30 that can be applied to the skin of a subject to perform a skincare procedure as illustrated schematically in FIG. 2.

The treatment head 30 is interchangeable. The treatment head 30 is removably mounted to the main body 20. Although the treatment head 30 is interchangeable, it will be understood that in an alternative embodiment the treatment head 30 is fixedly mounted to the main body 20. The treatment head 30 of the embodiments described herein is configured to be used on the periorbital area of skin of a user. That is, the tissues surrounding or lining the orbit of the eyes of the subject. However, it will be understood that the treatment head 30 may also be used on, for example, skin burns and insect bites on skin on other parts of the subject's body.

Reference 110a indicates a device axis. This is a body axis or longitudinal axis. In general, the device will have an elongated shape, configured to fit in the hand and configured to be at least partially enclosed during use by a hand (see also FIG. 2). Therefore, especially the main body is elongated, and may have a length of at least 5 cm, and an aspect ratio of at least 2, such as at least 5 (see FIGS. 1 and 2). Reference 130 indicates a rotational axis of the treatment head, herein also indicated as “treatmenthead axis”. In FIG 1 the device axis 110a and the treatment head axis 130a are alligned parallel, i.e. having a mutual angle α of 0°. In FIG. 2 the device axis 110a and the treatment head axis 130a have a non-zero mutual angle α. Especially, the device 10 has an angle α between the device axis 110a and the treatment head axis 130a in the range of 0-45°, especially 0-35°. In FIG. 1, the angle α is substantially 0° and in FIG. 2 the angle α is in the range of 20-30°.

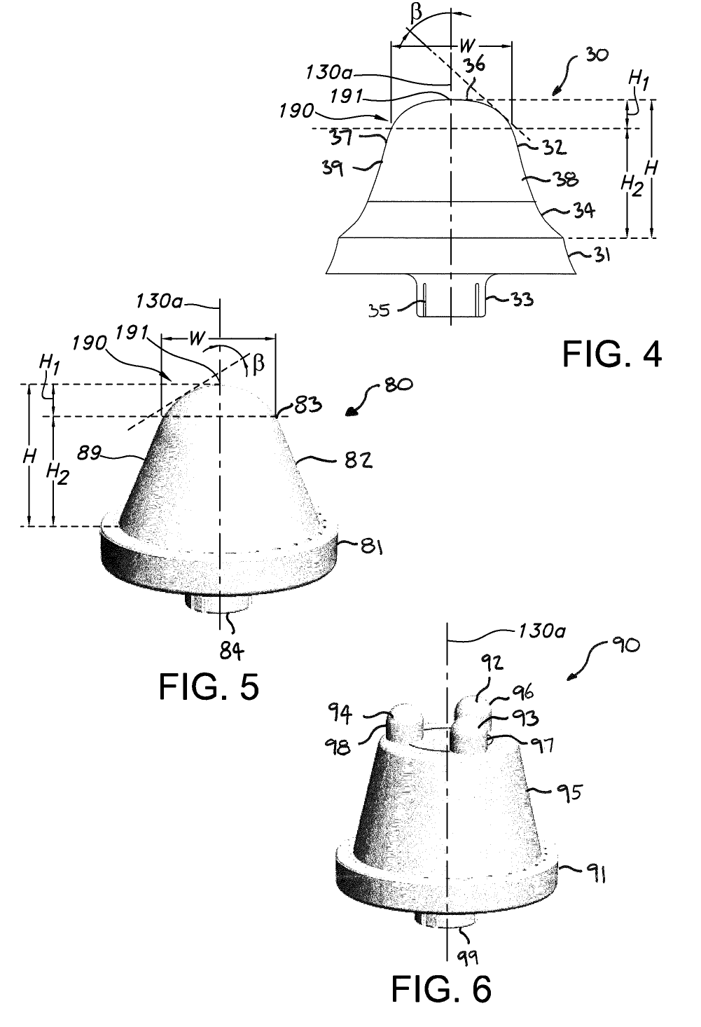

Referring to FIG. 4, the treatment head 30 comprises a base 31 and a treatment section 32. The treatment head 30 has a connector 33 for connecting the treatment head 30 to the main body 20. The treatment head 30 is generally radially symmetric. The treatment head 30 has a longitudinal axis. The treatment head 30 is radially symmetric about the longitudinal axis. The longitudinal axis defines that rotational axis of the treatment head 30. The connector 33 extends along the longitudinal axis.

An intermediate section 34 is disposed between the base 31 and the treatment section 32. The intermediate section 34 is formed from a material which is transparent to radio waves, such as plastic. It will be understood that the intermediate section 34 may be omitted, or the base 31 may be formed from a material which is transparent to radio waves.

The base 31 has a generally cylindrical body. A peripheral face of the base 31 converges from a lower end of the base 31 to an upper end. The connector 33 extends from the lower end of the base 31. The connector 33 is integrally formed with the base 31 in the present embodiment. The connector 33 has an engagement arrangement 35 for fixedly mounting the connector 33 to the drive shaft 41 (see also FIG. 3). The engagement arrangement 35 comprises ridges which are configured to engage with corresponding elements (not shown) on the drive shaft 41 to ensure that the treatment head 30 rotates together with the drive shaft 41 when the treatment head 30 is mounted thereon.

The treatment section 32 is on an upper side of the base 31. The connector 33 extends from an opposing side of the base 31 to the treatment section 32. The intermediate section 34 extends from the upper end of the base 31 and the treatment section 32 extends from the intermediate section 34. The intermediate section 34 may be omitted such that the treatment section 32 extends from the upper end of the base 31 (refer to FIG. 5). As shown in FIGS. 4-5, the treatment head 30,80 includes a treatment head section 190. This treatment head section is the section from the extremity 191 (may also be indicated as “apex”) until that part of treatment head wherein an tangent with a part of the treatment surface 37,83 and the treatment head axis does not have a smaller angle beta than another part of the treatment surface closer to the extremity 191 of the treatment head. This treatment head section is in these drawings indicated with the part between the extremity 191 and the horizontal dashed line. Especially good test panel results are obtained when the treatment head section has a largest diameter w in the range of 7-30 mm, such as 12-30 mm, such as especially 17-23 mm. the treatment head section 190 may have a height (H1) in the range of 1-10 mm, especially in the range of 2-7 mm. The total height of the treatment head (excluding the base 31,81,91) may be in the range of 10-35 mm, such as 10-25 mm, like especially 15-25 mm (i.e. H=H1+H2, wherein H2 indicates the height of the remaining part of the treatment section and the optional intermediate section 34).

Hence, especially the treatment is conically shaped with a rounded top (or apex). Further, the dimension are especially in the range of 70-130% of the dimensions of a finger or a knuckle (of the hand), as both are often used in massage techniques. Hence, the dimensions may be chosen such that the treatment head has the shape and dimensions similar to a finger or knuckle (of the hand). Here, “finger”especially refers to a distanl phalanx of an adult, such as the distanl phalanx of a ring finger, middle finger, index or thumb, which in general have a length in the range of 1-2.5 cm and a equivalent circular diameter in the range of 0.7-3 cm.

The treatment section 32 is radially symmetric. The treatment section 32 is dome shaped. That is, the treatment section 32 has a curved profile. The dome shape of the treatment section 32 in the present embodiment has a rounded conical profile. A vertex 36 of the treatment section 32 is rounded. The vertex 36 of the treatment section 32 has a radius of 6.5 mm in the present embodiment.

The treatment section 32 has a treatment surface 37. The treatment surface 37 is configured to be placed against the skin of a subject. The treatment surface 37 defines the outer surface of the treatment section 32. The treatment surface 37 has a linear profile side portion 39. However, it will be understood that the side portion 39 may have a concave profile, or in another embodiment a convex profile. In FIG. 5, the side portion is indicated with reference 89. It especially appears desirable when the side portion 39,89 has a linear part (i.e. a conical shape) having a height less than 50% of the height H. The treatment head of FIG. 4 was perceived more pleasant and (thus) effective than the treatment head of FIG. 5.

The treatment surface 37 has a surface roughness Ra between 1 μm and 4 μm. Preferably, the treatment surface 37 has a surface roughness Ra between 1 μm and 2 μm. The treatment surface 37 is configured for use on the periorbital area of skin of a subject without dragging on the skin of the subject. Therefore, the treatment head 30 is able to glide over the surface of the skin when applied thereagainst. The treatment section 32 and therefore the treatment surface 37 is fixedly mounted relative to the base 31. Therefore, the treatment surface 37 is not movable relative to the base 31.

The treatment surface 37 is formed by an outer layer 38 of the treatment section 32. The outer layer 38 of the treatment section 32 has a heat transfer coefficient capable of drawing heat from the area of skin to be treated. The outer layer is formed from a material having a specific heat capacity greater than or equal to 0.4 J·g−1·K−1. The outer layer 38 forming the treatment surface 37 has a thickness of equal to or greater than 1 mm, and preferably 4 mm. For example, for aluminium forming the outer layer, it has been found that the outer layer 38 should have a thickness of at least 1 mm, and preferably up to 4 mm, to enable an effective cooling treatment to be applied. In the present embodiment, the outer layer has a thermal conductivity of greater than or equal to 10 W·m−1·K−1. This ensures that heat is drawn from the periorbital area of skin of a subject to cause a cooling effect on the periorbital area of skin. With such an arrangement it is possible to passively cool the periorbital area of skin without the need for any additional cooling arrangement.

Experiments showed that an application of the device for only 15 seconds already lead to a cooling of the skin in the order of −4° C. (with a stainless steel treatment head). Thereafter, the skin starts to return to an average skin temperature but this may last in the order of 2-3 minutes. The cooling is perceived by members of test panels as pleasant and effective. This effect may even be stronger with aluminum. Hence, with the present device a cooling effect of the perorbital skin of minutes may be generated.

It will also be understood that the treatment surface 37 may apply a heating effect on the periorbital area if the treatment head 30 is warmed prior to application on the periorbital area of skin. For example, for aluminium forming the outer layer, it has been found that the outer layer 38 should have a thickness of at least 1 mm, and preferably up to 4 mm, to enable an effective warming treatment to be applied.

In the present embodiment, the outer layer 38 is formed from anodised aluminium. However, it will be understood that other suitable materials may be used. With the above described arrangement, it has been found that after 10 seconds of application to the periorbital area of skin an average temperature decrease of the skin of 3.8° C. is achieved.

Although one arrangement of the treatment head 30 is shown in FIGS. 1 to 4, it will be understood that alternative arrangements are possible. For example, in FIG. 5 an alternative embodiment of a treatment head 80 is shown. This treatment head 80 is generally the same as the treatment head 30 described above, and so a detailed description will be omitted. However, in this embodiment a treatment section 82 extends to a base 81. Furthermore, the profile shape of the treatment section 82 differs. The treatment section 82 has a treatment surface 83. A connector 84 extends from an opposing side of the base 81 to the treatment section 82.

Another embodiment of a treatment head 90 is shown in FIG. 6. This treatment head 90 is generally the same as the treatment head 30 described above, and so a detailed description will be omitted. Although in the above described embodiments, the treatment head 30 has one treatment section 32, it will be understood that the number of treatment sections may vary. In the embodiment shown in FIG. 6 the treatment head 90 has three treatment sections 92, 93, 94. Each treatment section 92, 93, 94 extends from an intermediate section 95. The intermediate section 95 is disposed between each treatment section 92, 93, 94 and the base 91. It will be understood that the intermediate section 95 may be omitted. The treatment head 90 is generally radially symmetric. The treatment head 90 is radially symmetric about the longitudinal axis. The longitudinal axis defines that rotational axis of the treatment head 90. The intermediate sections 92, 93, 94 are disposed symmetrically about the longitudinal axis. A connector 99 extends from an opposing side of the base 91 to the treatment sections 92, 93, 94.

Each treatment section 92, 93, 94 is radially symmetric. Each intermediate section 92, 93, 94 has a curved profile. A vertex of each intermediate section 92, 93, 94 is rounded. Each intermediate section 92, 93, 94 has a treatment surface 96, 97, 98 respectively. The treatment surface 96, 97, 98 of each intermediate section 92, 93, 94 is configured to be placed against the skin of a subject.

As shown in FIG. 3, the bodycare device 10 has a driver 40 for actuating the treatment head 30. The treatment head 30 is received on a drive shaft 41. The connector 33 (not shown in FIG. 3) connects the treatment head 30 to the driver 40. In the present embodiment, the connector 33 is mounted to the drive shaft 41 by the engagement arrangement 35 (not shown in FIG. 3). The drive shaft 41 is driven by a drive train which may include a first electric motor 42, acting as a first actuator, a reduction gear 43 and a second electric motor 44, acting as a second actuator. Alternatively, the second actuator is a vibration coil, for example. The first electric motor 42 rotates the drive shaft 41 through the reduction gear train 43, and the second, vibratory motor 44 imparts a vibratory motion to the drive shaft 41 in addition to the rotation produced by the first electric motor 42. The first and second electric motors 42, 44 receive respective electrical drive currents from a rechargeable battery 45 under the control of a microcontroller 46. The rechargeable battery 45 is charged through an inductive charger 50 which includes an inductive coil and rectifier arrangement 51 within the main body 10, which is inductively coupled to an AC driven coil within a charging cradle 60 illustrated in FIG. 1, in which the bodycare device 10 is received when not in use. The charging arrangement may operate generally in the manner of the charger provided for the VisaPure facial cleaning brush manufactured and sold by Royal Philips N.V.

The microcontroller 46 has an associated memory 47 which stores data corresponding to a series of drive parameters that are selected by the microcontroller 46 to control operation of the driver 40 to perform the skincare procedure which corresponds to the treatment head 30. The microcontroller 46 is configured to refer to the memory 47 to receive information of the skincare procedure. The treatment head 30 may be provided with an identity tag in the form of a RFID passive tag 70 attached to the treatment head 30. However, it will be appreciated that an active RFID tag could be used. The main body 30 includes a wireless transceiver, typically in the form of a near field communication (NFC) transceiver 48 which acts as a sensor to detect the identity of the interchangeable treatment head 30. The device also includes a user input in the form of an on/off switch 49 for the entire device.

The first electric motor 42 runs continuously in operation and transmits to torque through the reduction gear 43 to the rotary drive shaft 41. The treatment head 30 is received at one end of the drive shaft 41 with a push-fit. The NFC transceiver 48 has an associated transmit/receive coil (not shown) which communicates with the RFID tag 70 on the treatment head 30, so as to ascertain the identity of the treatment head 30 fitted to the driver 40. The RFID tag 70 is received in the base 31. Signals are able to pass through the intermediate section 34.

The second electric motor 44 imparts a longitudinal, axial, vibratory motion to the treatment head 30, in addition to the rotation produced by the first electric motor 42. The second electric motor 44 includes a flux assembly or magnetic member 40 which cooperates with a drive coil or solenoid (not shown) that receives current from the microcontroller 46 to impart a vibratory motion to the drive shaft 41. A more detailed explanation of the construction and operation of the first and second electric motors 42, 44 can be found in WO2014009177A1.

Alternative driver configurations to rotate and/or apply a vibratory motion to the treatment head 30 are possible. For example, the vibratory motion applied to the drive shaft 41 need not necessarily be produced by the second motor 44. Instead, a mechanical arrangement may be provided so that on rotation of the drive shaft 21, it is subject to a hammer action axially so as to produce the vibratory motion. Alternatively, a vibrating plate may impart the vibratory motion to the drive shaft 41.

In use, the skincare device 10 performs a skincare procedure to respective zones of the periorbital area of skin of the subject. The fitting of the treatment head 30 to the drive shaft 41 is detected by the transceiver 48 detecting the RFID tag 70.

The drive parameters for the treatment head 30 fitted to the drive shaft 41 are looked up, either by reading them from the data stored on the RFID tag by means of transceiver 48 or, if they have previously been stored in the memory 47, by retrieving them from the memory 47. The drive parameters may be stored in a reference profile, for example in the form of a look-up table.

For the treatment head described herein, the drive parameters are as follows. The driver 40 is configured to cause a rotational motion of 150 rpm. The rotational motion may be between 100 rpm and 200 rpm. Preferably, the driver 40 is configured to cause a rotational motion between 120 rpm and 170 rpm.

The driver 40 is configured to cause an axial vibratory motion having an amplitude of 30 μm. The amplitude maybe greater than or equal to 20 μm. Preferably, the driver 40 is configured to cause an axial vibratory motion having an amplitude of greater than or equal to 30 μm.

The driver 40 is configured to cause an axial vibratory motion having a frequency of 120 Hz. The frequency may be between 50 Hz and 150 Hz. Preferably, the driver 40 is configured to cause an axial vibratory motion having a frequency between 100 Hz and 140 Hz. This frequency is appreciated most by members of test panels. In terms of refreshing feeling, effectiveness, skin-friendliness, gliding perception and comfort, best results were obtained within especially the 100-140 Hz range. Frequencies below about 50 Hz, such as 30 Hz were perceived by members of test panels as not effective. Frequencies over 150 Hz also appeared not desired.

It has been found that the combination of the treatment head 30 having a rotational motion, and axial vibratory motion and a temperature changing effect on the periorbital area of the skin of a subject when applied to the skin has a synergistic effect in the maximising of the drainage of lymph fluid from the periorbital area of the skin. This means that puffiness of the skin may be minimised at an increased rate. The frequency may be modulated to provide the user with increased feedback during use of the device.

The first motor 42 drives the treatment head 3 at the predefined rotational speed and the second motor 44 imparts the predefined axial vibratory motion. The user manoeuvres the treatment head 30 into contact with the periorbital area of the skin of the subject, which may be the user, and draws the treatment head 30 across the skin. As the treatment surface 37 has a surface roughness Ra between 1 μm and 4 μm, the treatment head 30 is able to glide over the skin without dragging on the skin. The treatment head 40 imparts a rotational motion and an axial vibratory motion on the skin. This provides a gentle massaging feel.

When the treatment surface 37 is in contact with the skin, heat is transferred from the skin to the treatment head 30. Therefore, the temperature of the skin is reduced. As the treatment head 30 rotates, the section of treatment surface 37 in contact with the skin changes, and so the rate at which one section of the treatment surface 37 increases in temperature is minimised. During a warming procedure, it will be understood that heat is transferred from the treatment head 30 to the skin. Therefore, the temperature of the skin is increased. An urging force is applied on the skin by the treatment head 30, which is applied by the curved surface, and so fluid in the skin is urged to move. The vibratory motion of the treatment head 30 radiates into the skin to encourage the dispersion of the fluid. The combination of the above promotes the drainage of accumulated lymph fluid.

The controller 46 is configured to rotate the treatment head 30 in a first direction, for example clockwise. In response to a user input, the controller 46 is configured to rotate the treatment head 30 in a second direction, for example anti-clockwise. It has been found that using anti-clockwise rotation around the right eye, and clockwise around the left eye minimises the pull on the skin and maximises control of the device 10.

In an alternative embodiment, the controller 46 is configured to rotate the treatment head 40 in one direction for a predetermined period of time, for example 10 seconds, and then to reverse the direction of rotation for another predetermined period of time, for example 10 seconds. This allows the treatment head 40 to rotate in one direction to be used on one periorbital area of the skin of the subject, for example around the left eye, and then to be used on one periorbital area of the skin of the subject, for example around the right eye. The change in direction may be used as an indicator to a user of the length of time that treatment should be applied to each area. Alternatively, the treatment head 30 is rotated in one direction only.

It will be understood that the treatment head 30 may be used with a topical fluid, such as moisturising eye cream or gel. As the treatment section 32 is fixedly mounted relative to the base 31 of the treatment head 30, it will be understood that accumulation of the topical fluid by the treatment head 30 is minimised.

Although in the present arrangement the treatment head 30 is removably mounted to the driver 40, it will be understood that in an alternative arrangement the treatment head 30 is fixedly mounted to the driver 40.

Tests were performed with different surface roughnesses in the range of about 0.5-15 μm. It appeared that moving the treatment head over different types of surfaces was best with surface roughnesses over about 0.75 μm and below about 10 μm. Especially in the range of 1-4 μm. the properties seem best with a desired sensitive abrasion.

It will be appreciated that the term “comprising” does not exclude other elements or steps and that the indefinite article “a” or “an” does not exclude a plurality. A single processor may fulfil the functions of several items recited in the claims. The mere fact that certain measures are recited in mutually different dependent claims does not indicate that a combination of these measures cannot be used to an advantage. Any reference signs in the claims should not be construed as limiting the scope of the claims.

Although claims have been formulated in this application to particular combinations of features, it should be understood that the scope of the disclosure of the present invention also includes any novel features or any novel combinations of features disclosed herein either explicitly or implicitly or any generalisation thereof, whether or not it relates to the same invention as presently claimed in any claim and whether or not it mitigates any or all of the same technical problems as does the parent invention. The applicants hereby give notice that new claims may be formulated to such features and/or combinations of features during the prosecution of the present application or of any further application derived therefrom.

1. A bodycare device for a performing skincare prodcedure on periorbital area of a subject comprising:
a treatment head with a treatment surface having a curved profile and a surface roughness Ra between 1 μm and 4 μm and
a driver configured to cause a rotational motion and an axial vibratory motion of the treatment head.

2. The bodycare device according to claim 1, wherein the treatment head is radially symmetric.

3. The bodycare device according to claim 1, wherein at least a section of the curved profile of the treatment surface is dome shaped.

4. The bodycare device according to claim 3, wherein the curved profile of the treatment surface is a rounded conical profile.

5. The bodycare device according to claim 1, wherein the treatment head comprises two or more treatment sections and each treatment section forming treatment surfaces.

6. The bodycare device according to claim 1, wherein the treatment head is configured for use on a periorbital area of a subject.

7. The bodycare device according to claim 1, wherein an outer layered forms the treatment surface, and the outer layer has a heat transfer coefficient capable of drawing heat from the periorbital area of a subject.

8. The bodycare device according to claim 7, wherein the outer layer has a thermal conductivity of greater than or equal to 10 W·m−1·K−1.

9. The bodycare device according to claim 1, wherein the treatment surface has a surface roughness Ra between 1 μm and 2 μm.

10. (canceled)

11. The bodycare device according to claim 1, wherein the driver is configured to rotate the treatment head about a symmetrical axis of the treatment head.

12. The bodycare device according to claim 1, wherein the treatment head has a connector to connect the treatment head to a main body of the bodycare device, the or each treatment surface being fixedly disposed relative to the connector.

13. The bodycare device according to claim 1, wherein the driver is configured to cause a rotational motion between 100 rpm and 200 rpm and, preferably, between 120 rpm and 170 rpm.

14. The bodycare device according to claim 13, wherein the driver is configured to cause an axial vibratory motion having an amplitude of greater than or equal to 20 μm and, preferably, 30 μm.

15. The bodycare device according to claim 14, wherein the driver is configured to cause an axial vibratory motion having a frequency between 50 Hz and 150 Hz and, preferably, between 100 Hz and 140 Hz.
